(19) United States
(12) Patent Application Publication
(10) Pub. No.: US 2005/0121645 A1
(43) Pub. Date: Jun. 9, 2005

(54) De-icer apparatus

(76) Inventor: Mark R. Prescott, Stephentown, NY (US)

Correspondence Address: Francis C. Hand, Esq.;c/o Carella, Byrne, Bain, Gilfillan, Cecchi,, Stewart & Olstein, 5 Becker Farm Road, Roseland, NJ, 07068, US

(21) Appl. No.: 10/991,807

(22) Filed: Nov. 18, 2004

Related U.S. Application Data
(60) Provisional application No. 60/523,437, filed on Nov. 19, 2003.

(51) Int. Cl. C09K 3/18

(52) U.S. Cl. 252/70

(57) ABSTRACT

The de-icer apparatus uses the warmer water below an ice cap on a fishpond to maintain an opening in the ice cap for venting gases generated below the ice cap. The de-icer apparatus uses a low voltage heater to warm the water entering the lower end of the apparatus and moves the water by convection to the upper end of the apparatus. In one embodiment, the heated water is moved out of the upper end of the housing to prevent the formation of ice. In another embodiment, the housing provides a chimney effect for venting gas and melting snow.

This invention claims priority of provisional Patent Application No. 60/523,437 filed on Nov. 19, 2003.

This invention relates to a de-icer apparatus. More particularly, this invention relates to a de-icer apparatus for use in ornamental ponds and the like.

As is known, outdoor ponds or pools, such as ornamental fishponds, Koi ponds, and water gardens, are usually made with liners to hold a body of water in place without leaking to the surrounding environment. Should these ponds be used in a climate where ice forms on the top of the pond, the combination of the ice formation on the top of the pond and the liner used to create the pond effect a sealing-in of the water. One result of such a sealing-in of the water is that gases that build up from decomposing organic materials within the pond cannot escape. As a result, the gases can lead to killing of the fish within the pond.

In order to prevent a build-up of detrimental gases within a pond sealed over by ice, use has been made of various types of de-icer devices to maintain a small hole in the ice so that the gases may escape and allow the fish within the pond to remain healthy.

Many of the de-icers which have been used operate electrically to heat the water to prevent ice from forming. Some of these de-icers operate at a high voltage with a power rating of 1000 to 1500 watts. Consequently, such de-icers are costly to operate. In addition, these de-icers keep a large portion of the pond free from ice thereby creating a hazard for small children. Other electrical de-icers operate on a low voltage, for example using 100 watts of electricity to heat the surface of the water.

Still other de-icer devices make use of air or pumped water in order to maintain an opening in any ice that forms over the surface of a pool. However, while air may work efficiently at maintaining a hole in the ice, if the pond is large enough, the air, however, cools the overall water temperature under the ice. This condition of cooler water causes stress on the fish in the pond and could kill them.

Accordingly, it is an object of the invention to provide a de-icer apparatus of inexpensive construction for preventing ice from forming over a body of water.

It is another object of the invention to provide a de-icer apparatus that is inexpensive to operate.

It is another object of the invention to provide a de-icer apparatus for de-gassing frozen ponds in an efficient manner.

Briefly, the invention provides a de-icer apparatus that utilizes a thermal layer of water under an ice cap to maintain an opening in the ice cap. The de-icer apparatus operates to warm a flow of water from a thermal layer of water under an ice cap and to direct the warmed flow of water by convection upwardly to the surface of the body of water to prevent the formation of ice thereat.

In one embodiment, the apparatus includes a housing having a passage for a flow of water, a heater mounted in the lower end of the housing for heating the water thereat for upward convection flow through the passage and a floatation device disposed at an upper end of the housing for suspension of the housing in a body of water.

The apparatus also includes a grid across a lower end of the housing for passage of water and gases from the body of water into the passage of the housing as well as an apertured cover across the upper end of the housing for exiting of the gases.

As is known, the water under an ice cap is warmer than the ice cap itself. By utilizing a thermal layer of this water and warming the water, for example by 20° F., less energy is required in order to effect a convection flow of the warm water from the bottom of the housing to the upper end of the housing.

The floatation device, for example a ring of buoyant material, allows the de-icer apparatus to float on the body of water. As ice forms on the surface of the water, the ice will envelop the floatation device without freezing over the floatation device and, particularly, the apertured cover of the housing. Thus, the de-icer apparatus itself will maintain an opening in the ice. In addition, any warmed water that is brought up through the housing of the de-icer apparatus and passes out of the apertures of the cover will also serve to prevent ice from forming about the apparatus to maintain an opening in the ice. At the same time as warmed water is brought up through the de-icer apparatus, any gases that build up from deep decomposing organic materials within the pond are also brought up and expelled through the apparatus. Thus, the de-icer apparatus insures that the gases escape and that any fish within the body of water remain healthy.

By using warmer water beneath the ice, less energy is required for the heater of the de-icer apparatus. For example, the heater may have a power heating output of as little as 25 watts. This has been found to keep an opening in an ice cap all winter and even in extremely cold climate zones.

In another embodiment, the apparatus includes a housing that extends upwardly as a chimney from the flotation device, for example by 12 inches. In addition, the housing has elongated slots in the upstanding sides to vent gases from the housing into the surrounding environment. The extent of the housing above the flotation device allows the de-icer apparatus to take on a large amount of snow before becoming blocked

These and other objects and advantages of the invention will become more apparent from the following detailed description taken in conjunction with the accompanying drawings wherein:

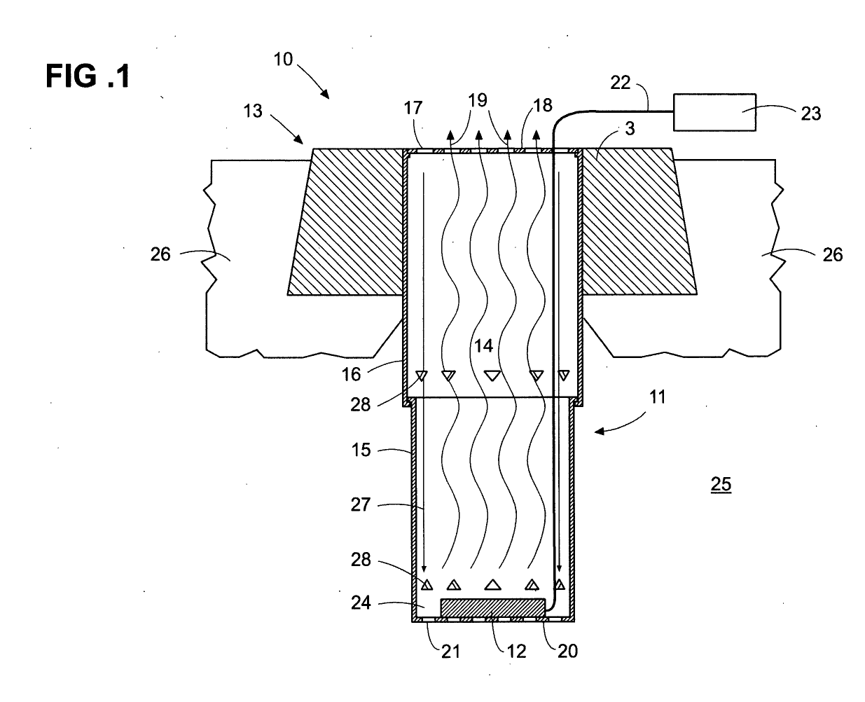

FIG. 1 illustrates a cross sectional view of a de-icer apparatus in a body of water in accordance with the invention;

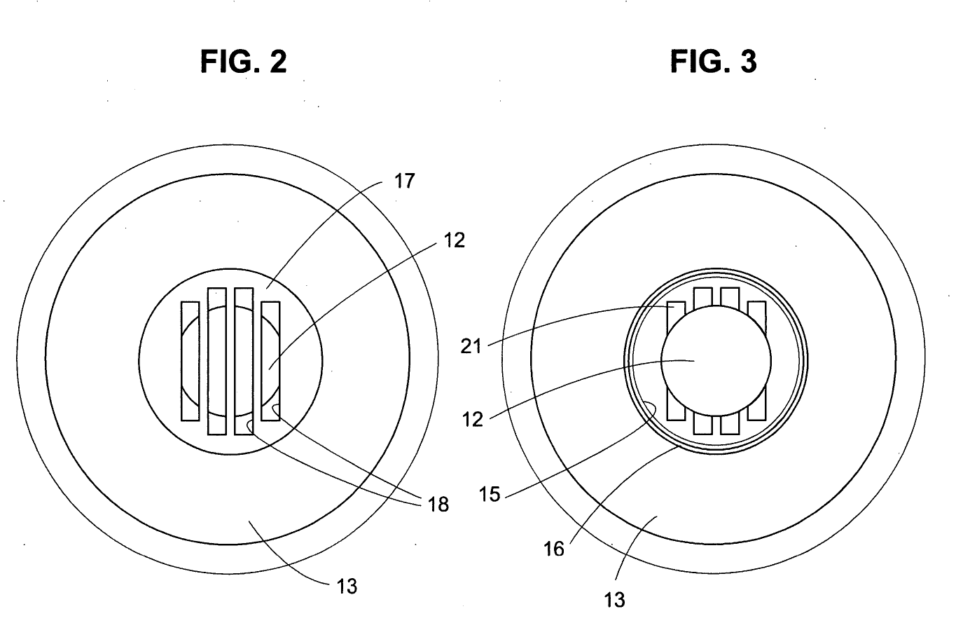

FIG. 2 illustrates a top view of the de-icer apparatus of FIG. 1;

FIG. 3 illustrates a top view of the de-icer apparatus of FIG. 1 with the cover removed; and

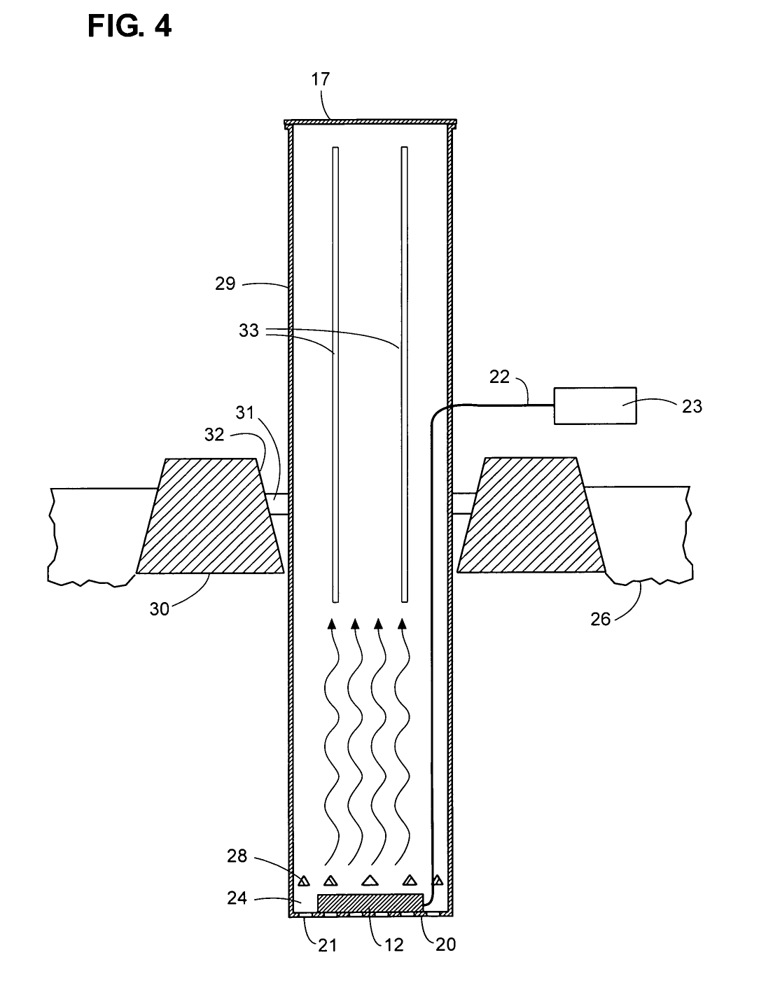

FIG. 4 illustrates a cross-sectional view of a modified de-icer apparatus in accordance with the invention.

Referring to FIG. 1, the de-icer apparatus 10 includes a housing 11, a heater 12 and a floatation device 13.

The housing 11 defines a passage 14 for a flow of water and is constructed, for example of a pair of tubes 15,16 that are disposed in telescoping relation to each other and that define the passage 14. As illustrated, the tubes 15,16 are of cylindrical cross-section but may be made of any suitable cross-section, such as polygonal or curvilinear shape. Also, multiple tubes may be used to extend the overall length of the housing 11 or one tube of a desired length may be used. The tubes 15,16 slide one within the other so as to be collapsed into a more compact condition for shipping and packaging purposes.

The housing 11 also has a cover 17 across the upper end of the upper tube 16. This cover 17 includes a plurality of apertures 18, for example, of rectangular shape (See FIG. 2), for passage of gases therethrough, as indicated by the arrows 19, from the lower end of the housing 11.

The housing 11 also has a grid 20 across the lower end of the tube 15 that has a plurality 21 of openings for passage of water and gases from the body of water into the passage 14 of the housing 11.

The heater 12 is disposed on the grid 20 and operates under a low voltage, for example with a heating output of 25 watts. Preferably, the heater 12 is a 60 watt heater that provides additional heat to provide better lift and to move more water up and down the tube 16. For movement of a larger quantity of water a 100 watt heater can be used.

The heater 12 may be powered via an electrical line 22 extending to a suitable power source 23 or may be battery operated.

The heater 12 is mounted within the tube 15 of the housing 11 in a manner so as to be easily replaced in the event of a failure. For example, the heater 12 may simply sit on the grid 20 in an unconnected manner. Should replacement be necessary, the heater 12 can be lifted out of place and replaced by a fresh heater.

The heater 12 is mounted relative to the tube 16 to leave an annular gap 24 between the heater 12 and the lower tube 15 to allow water to pass into the housing 11 and be warmed by the heater 12.

The floatation device 13 is disposed about an upper end of the upper tube 16 and serves to suspend the housing 11 in vertical disposition within a body of water 25. The floatation device 13 may be of annular shape as indicated in FIGS. 2 and 3 or may be of any other suitable shape. Also, the flotation device 13 may be made of any suitable material that is buoyant or of any suitable construction, such as hollow, that is buoyant.

The flotation device 13 may be permanently secured to the housing tube 16 or may be removably secured about the housing tube 16.

As illustrated, the surface of the flotation device is flush with the surface of the cover 17 and is located above the surface of an ice cap 26 that forms over the body of water 25.

When in use, the floatation device 13 is intended to float 4 to 5 inches above the water level and thus act as a buffer to the cold air and ice cap 26 to protect the opening in the ice cap 26 made by the de-icer apparatus 10.

The de-icer apparatus 10 is initially placed in the body of water 25 before ice begins to form. Once the outside temperature falls and ice begins to form, the heater 12 is activated to warm the water in the lower end of the housing. As the water warms, the water begins to slowly rise upwardly through the passage 14 to the surface of the body of water 25. This warmed water serves to prevent ice from forming over the cover 17 and maintains an opening in the ice cap 26 to vent any gases that may accumulate within the body of water 25. The water is then cooled by a heat exchange and moves downwardly as indicated by the arrows 27 within the passage 14.

Referring to FIG. 1, each tube 15,16 of the housing 11 is provided with a plurality of circumferentially disposed openings 28. The openings 28 in the upper tube 16 are spaced below the floatation device 13, for example 6 inches below the floatation device 13, so that warmed water and gases may escape in order to prevent ice from forming about the outer surfaces of the housing tube 16 and to leave a cone of open water in the ice cap 26 through which gases may escape.

Because of the constant up flow of warm water, the de-icer apparatus 10 functions to efficiently de-gas frozen ponds. Further, cold water moves downwardly on the outside surfaces on the housing 11 causing a constant circulation in the water. This constant circulation breaks up the thermal layering in the body of water 25 that would otherwise inhibit a gas exchange. In addition, the rising and falling of the water in the tube 16 exposes the water to oxygen and serves to aerate the body of water 25, for example, a pond.

Referring to FIG. 4, wherein like reference characters indicate like parts as above, the de-icer apparatus 10′ includes a one piece cylindrical housing 29, for example having a diameter of 4 inches, that is mounted in circumferentially spaced relation in a flotation device 30 via a plurality of attachment brackets 31. As illustrated, the flotation device 30 has a central opening 32 of downwardly-directed conical shape through which the housing 29 passes in spaced relation.

The housing 29 is of a length to depend, for example 12 inches below the underside of the flotation device 30 and to extend, for example 12 inches above the topside of the flotation device 30.

The housing 29 also includes a plurality of longitudinally elongated slots 33, for example four, in the sides of the exposed end that are disposed circumferentially of the housing 29 in order to vent gas from the interior of the housing 29 rather than being backed up. These slots 33 serve to make the de-icer apparatus 10′ more efficient and allows a larger hole to be maintained in the ice cap 26. As illustrated, the slots 33 extend from 2 inches below the top of the housing 29 to 2 inches below the underside of the flotation device 30. In this embodiment, the cover 17 is not provided with openings.

The slots 33 also allow heated water to flow out of the housing 29 in a plane below the underside of the flotation device 30 as well as within the plane of the flotation device 30. This allows the heated water to maintain an ice-free opening between the flotation device 30 and the housing 29. Depending on the wattage of the heater 28, more or less quantities of water can be moved through the slots 33. That is, the higher the wattage, the greater the amount of water is uplifted through the slots 33.

The heater 12 within the housing 29 is connected as above by a line 22 that passes through a wall of the housing 29 in sealed relation to a suitable power source.

The height of the housing 29 above the flotation device 30 allows any snow that falls about the housing 29 to be melted by the heat generated within the housing 29 thereby allowing a large amount of snow to fall before becoming blocked. The extended chimney effect provided by the housing 29 also moves air off the area of open water faster than if the area of open water were simply open, again moving gases away with the updraft generated by the housing 29.

The invention thus provides a de-icer apparatus which is able to maintain an opening in an ice cap while allowing gases trapped under the ice cap to escape from a body of water.

The invention also provides a de-icer apparatus that operates to circulate water without effecting the mean temperature of the water

The invention further provides a de-icer apparatus that can be made of a relatively small size for employment in fishponds, Koi ponds and the like or of a larger size to operate in larger bodies of water.

The invention relies on heat and convection for the movement of water rather that on a water pump or air pump. Thus, the invention provides a de-icer apparatus that is not only more efficient but also will not cool the body of water in which the apparatus is used.

1. A de-icer apparatus comprising
a housing having a passage therein for a flow of water;
a heater mounted in a lower end of said housing for heating water thereat for upward convection flow through said passage; and
a flotation device disposed about said housing for suspension of said housing in a body of water.

2. A de-icer apparatus as set forth in claim 1 wherein said housing includes a pair of tubes disposed in telescoping relation and defining said passage.

3. A de-icer apparatus as set forth in claim 1 further comprising a cover across said upper end of said housing, said cover having a plurality of openings for passage of heated water and gases there through from said lower end of said housing.

4. A de-icer apparatus as set forth in claim 3 further comprising a grid across said lower end of said housing, said grid having a plurality of openings for passage of water and gases from the body of water into said passage of said housing.

5. A de-icer apparatus as set forth in claim 1 wherein said housing includes a tube defining said passage and extending upwardly from said flotation device.

6. A de-icer apparatus as set forth in claim 5 wherein said tube includes a plurality of elongated slots located above said flotation device for venting gas from within said tube.

7. A de-icer apparatus as set forth in claim 5 wherein said tube is mounted in circumferentially spaced relation to said flotation device.

8. A de-icer apparatus as set forth in claim 1 wherein said heater and said lower end of said housing define an annular gap for an upward flow of water from the body of water.

9. A de-icer apparatus as set forth in claim 1 wherein said housing has a plurality of circumferentially disposed openings below said flotation device for outward passage gas from said passage.

10. A de-icer apparatus as set forth in claim 1 wherein said housing includes a pair of tubes disposed in telescoping relation and defining said passage, one of said tubes being mounted in said flotation device in depending manner.

11. A de-icer apparatus as set forth in claim 10 wherein said flotation device is an annular ring of buoyant material.

12. A de-icer apparatus as set forth in claim 10 wherein said annular ring is circumferentially spaced from said housing.

13. A de-icer apparatus as set forth in claim 1 wherein said heater has a heating output of 25 watts.

14. A de-icer apparatus comprising
a housing having at least a pair of tubes disposed in telescoping relation and defining a passage for an upward flow of water;
a heater mounted in a lower end of one of said tubes of said housing for heating water thereat for upward convection flow through said passage; and
a flotation device disposed about an upper end of another of said tubes of said housing for suspension of said housing in a body of water.

15. A de-icer apparatus as set forth in claim 14 further comprising a perforated cover across an upper end of said one tube for passage of heated water there through and a perforated grid across a lower end of said another tube for passage of water from the body of water into said passage.

16. A de-icer apparatus as set forth in claim 15 wherein said flotation device is an annular ring of buoyant material.

17. A de-icer apparatus as set forth in claim 15 wherein said heater has a heating output of 25 watts.

18. A de-icer apparatus comprising
a housing defining a passage;
a flotation device disposed said housing for suspension of said housing in a body of water;
a grid across a lower end of said housing for passage of water from the body of water into said passage;
a heater mounted on said grid for heating water thereat for upward convection flow through said passage; and
an apertured cover across an upper end of said housing for venting of gas therethrough.

19. A de-icer apparatus as set forth in claim 18 wherein said housing includes at least a pair of tubes disposed in telescoping relation.

20. A de-icer apparatus as set forth in claim 18 wherein said housing has a plurality of circumferentially disposed openings below said flotation device for venting gases from said passage.

21. A de-icer apparatus as set forth in claim 18 wherein said flotation device is an annular ring of buoyant material.

22. A de-icer apparatus as set forth in claim 18 wherein said heater has a heating output of 60 Watts.

23. A de-icer apparatus as set forth in claim 18 wherein said heater is removably mounted on said grid.
